(19) United States
(12) Patent Application Publication
(10) Pub. No.: US 2008/0292215 A1
(43) Pub. Date: Nov. 27, 2008

(54) SELECTIVE TEXT FLIPPING AND IMAGE MIRRORING SYSTEM AND METHOD

(75) Inventors: Dale Ellen Gaucas, Rochester, NY (US); John C. Handley, Fairport, NY (US)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/752,670

(22) Filed: May 23, 2007

(51) Int. Cl. G06K 9/36

(52) U.S. Cl. 382/298

(57) ABSTRACT

Selectively flipping text and mirroring graphical elements of image without disrupting the readability of the overall image can be desirable. A multifunction device can manipulate an image by separating the image into a first object and a second object, processing the first object so as to mirror the first object about an axis, processing the second object so as to mirror a first position of the second object about the axis and arranging the second object at the mirrored position, and combining the first object and the second object to form an output image. The first object can include a graphical image and the second object can include text, and the second object can overlap the first object.

### BACKGROUND

Mirroring is an image manipulation operation in which an image is reflected about an axis. More specifically, an image can be mirrored when the sign of one of its two Cartesian coordinates is inverted. An entire image can normally be mirrored by using global X and Y coordinates that apply to the whole image, however certain image regions such as regions with text, characters, numerals, and the like, which are collectively referred to as text, are also mirror imaged. This can result in undesirable distortion of the mirrored image.

For example, a mirror image operation that implements a right-to-left reversal can result in a reflected copy of all of the image elements, including text. Specifically, the local directional isomorphism of text containing regions is not preserved. FIG. 3A shows an example of an image 302 with a graphical object 304, associated text 306, and exterior text 308. FIG. 3B is an example of the output 310 obtained from a technique that reverses all elements of image 302. As can be seen in FIG. 3B, mirroring was applied to all graphics and all text in the entire input image. As a result, the mirroring operation can distort the text and make it unreadable except for bilaterally symmetric text characters such as A, O, M, etc. Thus, such image manipulation can fail to provide the necessary features to mirror an image while preserving the local directional isomorphism of text within the image.

### SUMMARY

Selectively flipping text and mirroring graphical elements of image without disrupting the readability of the overall image can be desirable. In an embodiment, a multifunction device can manipulate an image by separating the image into a first object and a second object, processing the first object so as to mirror the first object about an axis, processing the second object so as to mirror a first position of the second object about the axis and arranging the second object at the mirrored position, and combining the first object and the second object to form an output image. The first object call include a graphical image and the second object can include text, and the second object can overlap the first object.

In an embodiment, the multifunction device can manipulate an image by separating the image into the first object and the second object and identifying regions of the image by an object type, including at least one of a graphical object, associated text object, and an exterior text object. The multifunction device can then process the first object so as to mirror the first object about the axis defined as a vertical line passing through a centroid of a graphical object by performing an arithmetic inverse on the horizontal axis coordinate of each pixel of the graphical object relative to the axis. The multifunction device can then process the second object by mirroring a first position of the second object about the axis by performing an arithmetic inverse operation on the horizontal axis coordinate of the first position relative to the axis.

### BRIEF DESCRIPTION OF THE DRAWINGS

The invention will be described with reference to the accompanying figures, wherein like numerals represent like elements, and wherein:

FIG. 1 shows an exemplary diagram of the selective text flipping and image mirroring system;

FIG. 2 shows an exemplary block diagram of the processor device of FIG. 1;

FIG. 3A shows an input image with a graphical object, associated text, and exterior text;

FIG. 3B shows the mirror image of the original graphical object and text;

FIG. 4A shows text detection and text bounding contour delineation in the original image;

FIG. 4B shows text being masked by replacing the text bounding contours with background;

FIG. 4C shows the mirror image of a graphical object;

FIG. 4D shows the merger of flipped text and the mirrored graphical object;

FIG. 5 shows an exemplary data structure for storing text and image data;

FIG. 6 shows an exemplary data structure for selected elements of FIG. 4;

FIG. 7 shows a flowchart outlining an exemplary process of the selective text flipping and image mirroring system; and

FIG. 8 shows an example of the selective text flipping and image mirroring system when text is not horizontal.

### EMBODIMENTS

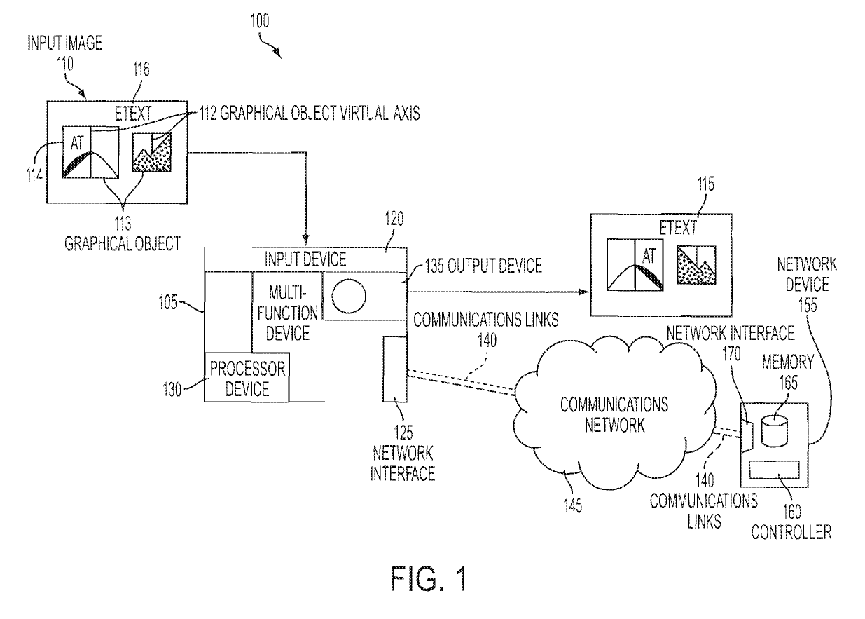

FIG. 1 shows an exemplary diagram of a selective text flipping and image mirroring system 100. The selective text flipping and image mirroring system 100 can include a multifunction device 105 and a network device 155. As shown in FIG. 1, the multifunction device 105 can be coupled with the network device 155 via communication links 140 and a network 145.

The multifunction device can perform functions, such as copying, scanning, faxing and the like. The multifunction device 105 can include an input device 120, a processor device 130 and an output device 135. The multifunction device 105 can further include a network interface 125 that is coupled to the network 145 via communication link 140. As described in greater detail below, the input device 120, network interface 125 and output device 135 can be coupled to and controlled by the processor device 130 to perform selective text flipping and image mirroring, as well as the other functions of the multifunction device 105.

The network device 155 can include a controller 160, memory 165 and network interface 170. The memory 165 and network interface 170 can be coupled to the controller 160. Further, the network interface 170 can be coupled to the network 145 via communication link 140. As described in greater detail below, the network interface 155 may provide a hosted service to the multifunction device 105. For example, the network device 155 may receive data from the multifunction device through the network 145 and communication links 140, and may implement processor intensive operations on the received data. Subsequently, the network device 155 can return the process data to the multifunction device 105 once processing has been completed.

Memory for images in electronic format is represented by an array of pixels. Each pixel has a position in two dimensions: a horizontal position and a vertical position. These positions may describe numbers of pixels from one position or physical extent.

By mathematical convention, the horizontal direction is called the x-direction and the vertical direction is called the y-direction. By mathematical convention and in image models such as Postscript, the lower left corner of the memory is called the origin. Horizontal positions or coordinates increase from left to right, vertical positions or coordinates increase from bottom to top.

An image is an array of values in this memory. Some values are designated as background and the others are designated foreground. For example, a binary image could have pixel value 0 as background and pixel value 1 as foreground. A gray-scale image, with values between 0 and 255 could have values 171 to 255 as background. A 24-bit color image with 8-bits for red, green, and blue values could have a background where red values are between 192 and 255, inclusive, green values are between 128 and 255, inclusive, and blue values are between 221 and 255, inclusive.

An image can have foreground pixels and background pixels. Two foreground pixels are four-connected if they differ by only one position either horizontally or vertically. Thus a pixel at position (x, y) has four connected neighbors (x-1, y), (x+1, y), (x, y−1), and (x, y+1) with this definition. Two foreground pixels are eight-connected if the horizontal position or the vertical position differ by one. Eight connectivity includes the diagonal pixels. A pixel at position (X, Y) has eight connected neighbors (X−1, Y), (X+1, Y), (X, Y−1), (X, Y+1), (X−1, Y−1), (X−1, Y+1), (X+1, Y−1), and (X+1, Y+1) with this definition. Other definitions of pixel connectivity are contemplated and can be found in the literature, including definitions using distances.

The foreground can be decomposed into sets of pixels that are connected to each other. It is possible for two foreground pixels not to be connected under a given definition of connectivity.

Each set of foreground pixels that are connected to each other is called a connected component. Connected components can be grouped together according to their function in an image. For example, some connected components are parts of characters and form text objects when grouped. Other connected components form drawings and are called graphical objects. Other connected components form photographs or pictorial objects.

It is possible for a connected component to be part of two different kinds of objects. For example, a character that is written on top of a long line will be part of a text object and part of a graphic object. Generally, a foreground image can be decomposed into connected components and those connected components grouped into pictorial objects, graphical objects, and text objects.

This method is directed toward processing graphical and text objects. Because graphical and text objects are designed by humans for communication on paper or other two dimensional displays, they have an intended orientation. Text is oriented according to the direction it is read, horizontally for left to right or right to left reading or vertically for top to bottom reading. Text can be oriented at other angles for stylistic reasons, but essentially has a single reading direction.

The direction of text objects can be determined by any known technique or algorithm. In an exemplary case, the direction of a text object is first determined then a bounding contour around that object can be found. For example, a bounding contour may be a rectangle with the smallest area such that two of the sides of the rectangle are parallel to the text direction. Such a text bounding box then has tour corners that can be labeled using the following procedure. In another exemplary case, the bounding contour can be found first then the direction of the text within the contour can be determined.

If the text bounding box were rotated so that the text is in its proper reading orientation, then the bounding box is a rectilinear orientation with sides parallel to the x and y axes in the rotated co-ordinate frame. The corner of the text bounding box corresponding to lower left corner of the rectangle when it is in this oriented position is called the text bounding box origin. To describe the operations of the method, each corner of the text bounding box may be denoted with a symbol. For example, the origin can be labeled A and, in counterclockwise direction, B, C, and D. In general, a text bounding contour may be circumscribed by a counterclockwise or clockwise closed path which is traversed in the same direction before and after text is flipped.

A graphical object has a bounding box that has sides that are parallel to the original, un-rotated x and y axes.

An object whether graphical or text, can be reflected in image memory about an axis to create the effect of viewing the object in a mirror. In this case, left and right directions are exchanged about the vertical line X=E, so that pixel values at positions (X₁, Y), . . . , (X₂, Y) are replaced by values at (2E−X₁, Y), . . . , (2E−-X₂, Y).

Typically the vertical line X=E represents a line going down the middle of the object. For example, if the object has a bounding box with sides parallel to the X and Y axes and corners A=(X₁, Y₁), B=(X₂, Y₁), C=(X₂, Y₂), and D=(X₁, Y₂) where X₁<X₂ and Y₁<Y₂, then a natural axis of reflection X=E has E=(X₁+X₂)/2. Reflecting about this line will provide the effect of minimal displacement or translation. One ordinarily skilled in the art can construct transformations to reflect vertically or in any orientation.

During operation, an original or source image 110 may be received by the input device 120 of the multifunction device 105. Once received, the input device 120 can transmit the input image data to the processor device 130. The processor device 130 can perform any necessary processing on the image data in order to modify the image. The processor device 130 can transmit the modified image data to the output device 135. Upon receipt of the image data, the output device 135 can generate, for example print, an output image 115 including the modified image having the text flipped and image mirrored.

As described above, the image and text manipulation task of the selective text and image mirroring 100 may be implemented in the multifunction device 105. Alternatively, the multifunction device 105 may share processing resources with the network device 155. In such a case, the network device 155 may provide a hosted service to the multifunction device 105. In other words, the network device 155 may implement processor intensive operations that the multifunction device 105 may not be capable of, or would otherwise consume too much time to complete. For example, the selective text flipping and image mirroring processing may be shifted to the network device 155 in order to reduce the processing load on the processor device 130 of the multifunction device 105.

Communication links 140 may be any type of connection that allows for the transmission of information. Some examples include conventional telephone lines, digital transmission facilities, fiber optic lines, direct serial/parallel connections, cellular telephone connections, satellite communication links, local area networks (LANs), Intranets and the like. The physical basis of communication links 140 can be any type of wired or wireless circuit-oriented, packet-oriented, cell-based connection-oriented or connectionless link, including, but not limited to, multiple twisted pair cable, DSL, coaxial cable, optical fiber, RF cable modems, over-the-air radio frequency, over-the-air optical wavelength (e.g. infrared), local area networks, wide area networks, intranets, virtual private networks, cable TV, terrestrial broadcast radio or television, LMDS, MMDS, satellite transmission, simple direct serial/parallel wired connections, or the like, or combinations of these.

Network 145 may be a single network or a plurality of networks of the same or different types. For example, the network 145 may include a local telephone network in connection with a long distance telephone network. Further, the network 145 may be a data network or a telecommunications or video distribution (e.g. cable, terrestrial broadcast, or satellite) network in connection with a data network. Any combination of telecommunications, video/audio distribution and data networks, whether a global, national, regional, wide-area, local area, or in-home network, may be used without departing from the spirit and scope of the present invention. For the purposes of discussion, it will be assumed that the network 145 is a single integrated voice, video and data network, that is either wired and/or wireless.

In FIG. 1, the source image includes a graphical object 113, associated text object 114 and exterior text object 116. As can be seen in the output image 115, the graphical object 113 and associated text object 114 can be mirrored and flipped, respectively, about graphical object virtual axis 112 while exterior text object 116 is neither flipped nor mirrored, but rather has its reading order, orientation and position preserved. In one embodiment, the graphical object virtual axis 112 may be determined from the centroid of the bounding box of graphical image 304. In one embodiment this centroid may be determined from the average of the maximum and minimum X-coordinates of the bounding box of graphical image 304.

In this specification, flip or flipped can refer to a transformation of the position and orientation of the contents of a text bounding contour using coordinate translation, coordinate rotation, and centroid reflection operations. In an exemplary case, these operations may be performed using an global coordinate system in which X represents a horizontal direction, Y represents a vertical direction, and the (0,0) origin of the coordinate system is at lower left hand corner of an image. In an exemplary case, mirroring a graphical object or the position of a centroid or a reference point of an associated text object may be implemented in a local coordinate system (X, Y) for a graphical element. In this case, each picture element's new local position is found by using a reflection matrix R so the new coordinate pair may be given by (X′, Y′) per the following equation:

$$[ \begin{matrix}{X}^{′} \\ {Y}^{′}\end{matrix} ] = [ \begin{matrix}- 1 & 0 \\ 0 & 1\end{matrix} ] [ \begin{matrix}X \\ Y\end{matrix} ] = R [ \begin{matrix}X \\ Y\end{matrix} ] \qquad ( 1 )$$

Translation operations may between local coordinates or between local and global coordinates may be given by:

$$[ \begin{matrix}{X}^{′} \\ {Y}^{′}\end{matrix} ] = [ \begin{matrix}A \\ B\end{matrix} ] + [ \begin{matrix}X \\ Y\end{matrix} ] \qquad ( 2 )$$

For example, centering associated text before rotation may be implemented using equation (2) using A=−X_{centroid} and B=−Y_{centroid}. Translation of associated text to a corresponding mirrored location may also be implemented with Equation (2).

Rotation operations may be implemented by:

$$[ \begin{matrix}{X}^{′} \\ {Y}^{′}\end{matrix} ] = [ \begin{matrix}cos φ & - sin φ \\ sin φ & cos φ\end{matrix} ] [ \begin{matrix}X \\ Y\end{matrix} ] \qquad ( 3 )$$

where φ refers to counterclock-wise rotation of a vector (X, Y).

Given these definitions, in one embodiment, a flipping operation on the contents of the text bounding contour with center coordinates (X_{centroid}, Y_{centroid}) may be implemented by subtracting (X_{centroid}, Y_{centroid}) from the coordinates of each pixel per equation (2) where A equals −X_{centroid} and B equals −Y_{centroid} then applying the rotation operation per equation (3) where φ equals 180°-2θ with θ taken from the orientation angle field 580 of region specifier 555 in data stricture 500.

In one embodiment, a reference point on the text bounding contour may be used to effect the flipping operation, as follows. First, a reference point A=(X₁, Y₁) that defines the origin of a rectangular text bounding contour for text in the normal reading direction is mapped to its corresponding position. The next three points, on the rectangular text bounding contour may be defined as B=(X₂, Y₂), C=(X₃, Y₃), and D=(X₃, Y₃). The ABCD contour order for horizontal associated text will have a horizontal AB line segment, and a contour that is closed counterclockwise. The flipping operation for this case will produce a reading order compatible contour of BADC. The ABCD contour order for vertically oriented associated text will have a vertical line segment AB (both upward and downward directions of the line segment are encompassed using this notation), and a contour that is closed counterclockwise. The flipping operation for these two cases will produce a reading order compatible contour of DCBA. In a further pair of cases of this example, if the reading order direction of the associated text is any angle relative to a reference angle defined by the horizontal axis and that angle is not equal to 90 degrees or −90 degrees, in particular if it is greater than −90 degrees and less than 90 degrees, and the ABCD order describes a contour that encloses a rectangular bounding contour in a counterclockwise direction, then the flipping operation for this case will produce a reading order compatible contour of BADC.

After centering and rotation, the flipping operation may be completed by translating the associated text's bounding contour to a corresponding position which may be located at approximately the mirror image position of the text bounding contour center. To distinguish associated text from exterior text all text that is within or crosses any graphical object's bounding box is defined as associated text; all other text is defined as external text,

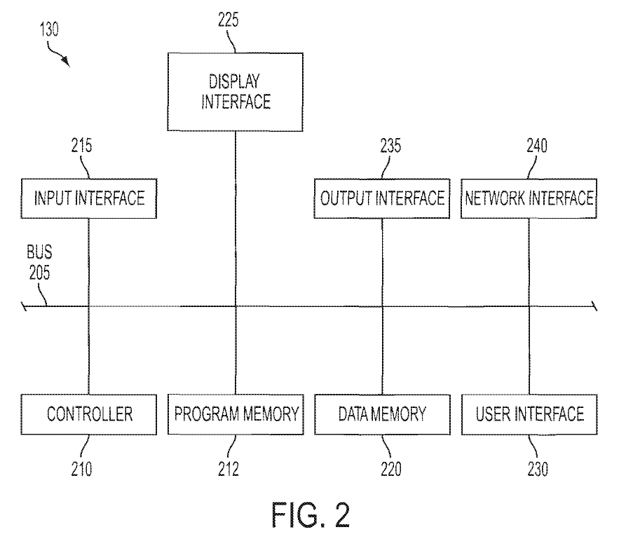

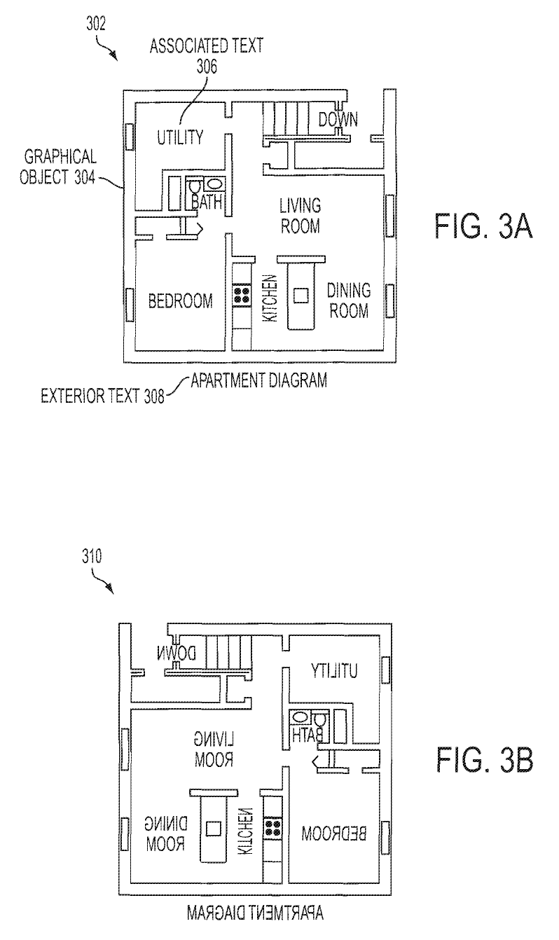

FIG. 2 shows the components of the processor device 130 of multifunction device 105 shown in FIG. 1. As shown, processor device 130 can include a controller 210, processor memory 212, input interface 215, data memory 220, display interface 225, user interface 230, output interface 235, and network interface 240. The above components may be coupled together through a control/signal bus 205.

During operation, the input interface 215 under the control of the controller 210 can receive an input image from the input device 120. Under the control of the controller 210, the input image data can either be directly processed by the controller 210 or temporarily stored in the data memory 220, or a combination thereof. In order to implement selective text flipping and image mirroring, the controller 210, may operate under the direction of a program stored in program memory 212. The controller 210 then modifies the image data to selectively flip text and mirror the graphical object data. The modified image may subsequently be stored in data memory 220.

Further, under control of the controller 210, the image may be displayed on a display device via the display interface 225. At this point, a user of the multifunction device may interact with the multifunction device via the user interface 230. For example, a user may wish to manipulate the modified image to remove distortion or otherwise improve quality. To accomplish this, a user may interact with the multifunction device through a user input device, such as a keypad, touch screen and the like. The user's inputs can be received by the controller 210 through the user interface 230, and further processing can be accomplished on the image data to change or improve the modified image as necessary.

Additionally, the controller 210 may offload processing via the network interface 240 to external processing resources, such as the network device 155. In such a case, the controller 210 may transmit image data via network interface 240 across the network 145 to the network device 155. As described above, the network device 155 can then perform the necessary processing to selectively flip text and mirror graphical objects in the image data and transmit the modified image data back to the multifunction device. The modified image data can then be received by the controller 210 via the network interface 240. In a similar manner to that above, the modified image can then be stored in data memory 220 and/or displayed on display interface 225.

Once the image has been modified by selectively flipping text and mirroring graphical objects, and possibly after being approved by a user, the controller 210 may then cause the modified image data to be transmitted to an output device via the output interface 235. For example, the modified image may be transmitted directly from the controller 210, or the modified image may be read out of data memory 220 and transmitted tinder the control of controller 210 to the output interface 235.

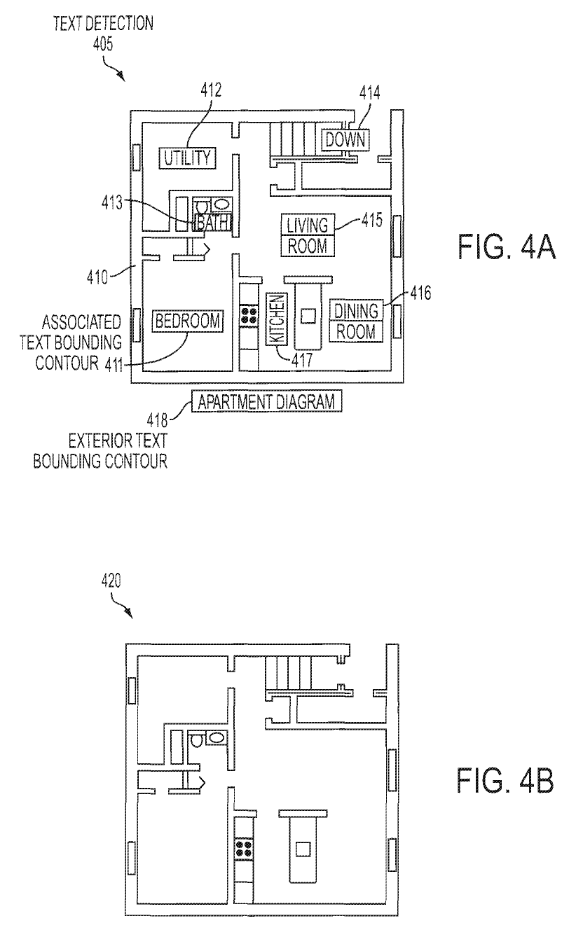

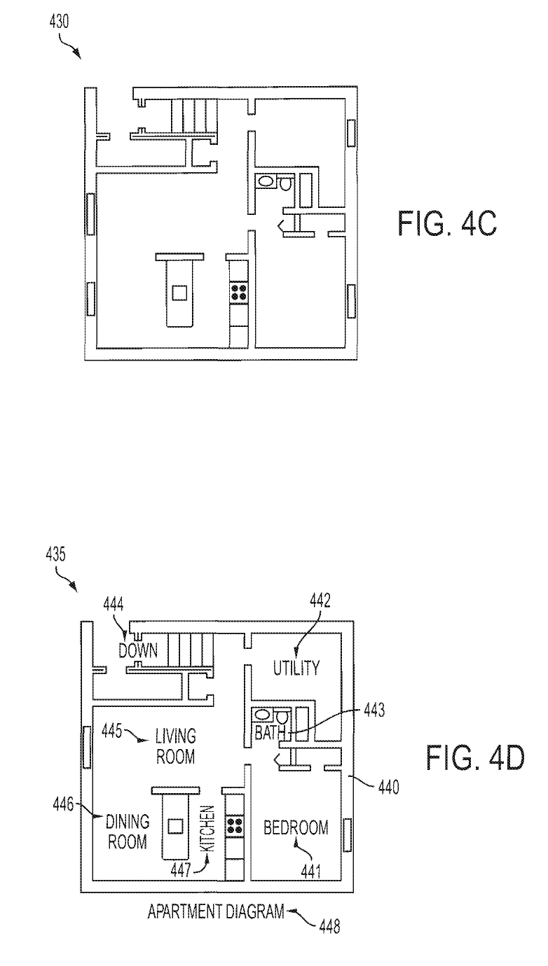

FIG. 4A shows an image 405 having text including a graphical object 410, a region enclosed by exterior text bounding contour 418, and associated text bounding contours 411-417. Each of these associated text bounding contours 411-417 are so designated because they are enclosed in a bounding box of a graphical object, specifically the graphical object 410. The associated text bounding contours can be determined by using any technique, such as those disclosed in U.S. Pat. No. 5,144,682, which is hereby incorporated by reference in its entirety. Alternatively, text and graphical objects may already be separated using the mixed raster content model, whereby text with or without some graphical objects and other graphical objects are represented on different layers of an image. It should be understood that text which crosses a graphical object bounding box may also be associated with that graphical object.

In FIG. 4A exterior text bounding contour 418 is neither enclosed in the bounding box of graphical object 410 nor does it cross the bounding box. Any text not enclosed in a graphical object bounding box nor crossing a graphical object bounding box may be designated exterior text. One associated object bounding contour 417 is shown vertically oriented while the remaining associated object bounding contours are shown as horizontal. In general, text bounding contours, whether associated text or exterior text are not restricted to any particular orientation and may be diagonal or at any angle including horizontal or vertical. Neither the associated text bounding contours 411-417 nor the exterior text bounding contour 418 explicitly appear in the original image 405. These bounding contours define regions of the original image that may be subject to either a flipping operation or are preserved regions, such as those enclosed by exterior text bounding contour 418. Each exterior text object occupies approximately the same global location and orientation in the output image 435 and exhibits a mapping into itself called an automorphism, in that the exterior text object is unchanged.

FIG. 413 shows graphical object 420 after the contents of regions designated as associated text or external text are replaced by a background pattern. The background pattern may be made of all white, all black, a gray-tone, or a given color. A background pattern may be determined by a histogram analysis of the image, or may be determined for a subset of the image in the proximity of each text bounding contour.

FIG. 4C shows mirrored graphical object 430. No exterior text or associated text are shown. As described above, the mirror image operation may have been performed about the centroid of graphical object 420 to produce graphical object 430. Alternatively, a mirror image operation of graphical object 420 may be performed for any offset axis, but if such axis is offset from the virtual axis obtained from a graphical object centroid, then after an offset mirror image operation, approximately twice the offset must be subtracted from the address of each pixel in the graphical object to translate the image to have the same final centroid.

FIG. 4D shows a merged output image 435 with graphical object 440, flipped text 441-447, and exterior text 448. The automorphism between exterior text 448 and exterior text 418 is evident in comparing FIG. 4D and FIG. 4A. The local directional isomorphism of flipped text and associated text is evident in comparing FIG. 4D and FIG. 4A, respectively. In other words, the appropriate left to right reading orientation is preserved.

As an example of the selective text flipping and image mirroring system in operation, suppose one has a condominium brochure describing a unit for sale. The brochure may contain general information on the amenities, square footage, dimensions, contact information, price or other information. The brochure may depict a floor plan which may be a line drawing with features labeled by one or more sets of text which may be horizontal or vertical or oriented at arbitrary angles. These condominium units may be offered in versions that are mirror images of each other, so the seller may want to provide a version of the brochure that shows the correct floor plan view of a particular unit. However, a seller may wish to provide a mirror image of the unit's floor plan that does not mirror either the text that labels items in the floor plan or other textual information. As described above, mirroring techniques implement a mirroring operation on the entire input image regardless of the presence of text. The selective text flipping and image mirroring system may provide mirroring of graphics and image manipulation functions for selectively flipping text and selectively mapping unassociated text from input image to output image without change. In one embodiment, the text flipping operation may make use of local X and Y coordinates by taking the arithmetic inverse of the local X coordinate. The local X coordinate for each graphical object 113 may be defined as the distance (in either the physical space or pixel space) relative to the graphical objects virtual axis 112. In another embodiment, the text flipping and image mirroring operations may be performed using a horizontal (X) and vertical (Y) coordinate system in which the lower left hand corner point is (0,0) and is called the origin.

The image manipulation operations of the selective text flipping and image mirroring system, may be discussed using the concept of a corresponding position for associated text and exterior text. A corresponding position may be defined as the location of the text's position centroid in the output image. The centroid may be computed from the average of the maximum and minimum global X-coordinates and the average of the maximum and minimum global Y-coordinates, or the median global (X, Y) position, or the average global (X, Y) position of a bounding contour containing text, or more generally from a weighted median or weighted average position of a contour region enclosing the text. Both the text bounding contour and the graphical object bounding box may be found using known algorithms. In general, text may appear in the input image at an angle θ (taken counterclockwise with respect to a graphical objects virtual axis). Such text becomes flipped text when it is rotated counterclockwise about its centroid by an angle of approximately 180°-2θ and placed in the output image at the corresponding mirrored position of its centroid. Given that the both input and output images may be represented as two-dimensional regions, global Cartesian (X, Y) coordinates may be used to locate regions in any image. Local X-coordinates and local Y-coordinates may also be defined; local coordinates may be taken relative to the global centroid co-ordinates of each graphical object. Local (X, Y) coordinates and graphical object centroids may be used to place associated text into corresponding positions while preserving the readability of such text.

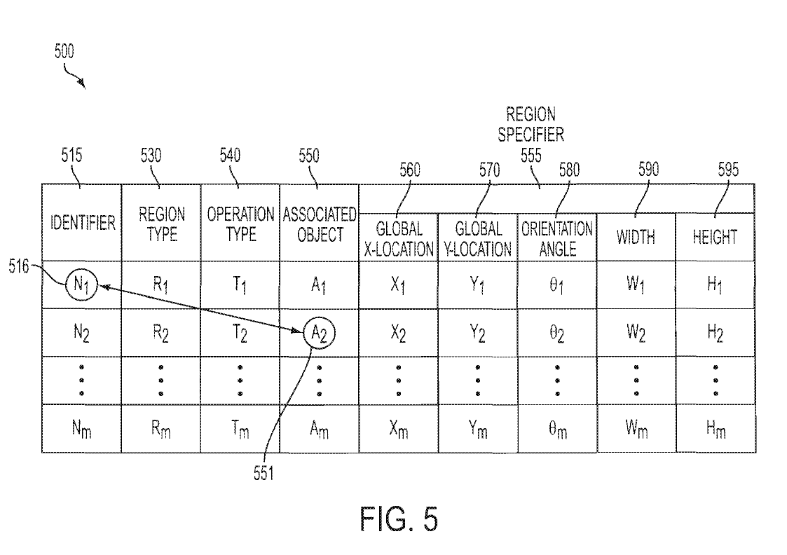

FIG. 5 shows an exemplary data structure 500 having multiple fields. As shown, data structure 500 can include field 515 that may be used to identify regions of the image, such as graphical object 410, associated text bounding contour 412, or exterior text bounding contour 414. Each identifier may establish a row of the data structure 500. Specifically, each of the entries in the region type field 530, operation type field 540, associated object field 550 and region specifier 555 correspond to the respective identifier in field 515. In one embodiment, identifier 515 may be a binary number that may be incremented for each region identified. Identifier field 515 contents may be used in other fields. For example, identifier 516 may be used in associated object field 550. Specifically, the contents of identifier 516, N₁, may be placed in A₂ of associated object 551. If N₂=2 and A₂=1 then the second region is associated with the first region. Image manipulation operations on associated text objects may be performed with respect to local coordinate system given by a centroid of the region given by the contents of an associated object field 550. In the specific example above, the centroid of region 1 may be used to define a local coordinate system and a virtual axis for manipulating region 2. The virtual axis of region 1 may be taken in an exemplary case, from the X coordinate, X₁, of region 1. A calculation using the global X coordinate X₂ yields the local X-coordinate of a mirror position called a corresponding position of region 2: −(X₂−X₁). When this value is placed back in the global (X, Y) coordinate system the global X coordinates will be X₁+[−(X₂−X₁)]=2X₁−X₂. From this example as with a previous example, it is clear that mirroring a point about an arbitrary axis may be accomplished by changing the sign of an X coordinate and translating by twice the value of the mirror axis.

Operation type field 540 may determine whether the region will be preserved (i.e., neither mirrored nor flipped), mirrored, or flipped, which may be a more general set of operations than mirroring. In one embodiment, identifier 515 may be implemented in a 16 bit word, region type field 530 may be two ASCII characters, and operation type field 540 and associated object field 550 may each be implemented in 8 bit words.

Region specifier 555 provides a sufficient dataset for defining the position, orientation, and dimensions of a region. The position information may require two coordinates. A global X coordinate may be recorded in global X location 560 and a global Y coordinate may be recorded in global Y location 570. These coordinates may be regarded as global as they pertain to the location (X, Y) in the input image. Equivalent formulations of (X, Y) coordinates or the use of other coordinate systems such as polar coordinates do not circumvent the need to unambiguously define object locations. Region specifier 555 may be implemented in 16 bit words.

Orientation angle 580 may be defined with respect to a virtual axis of a graphical object the region of interest is associated with. When virtual axes are parallel, any virtual axis or the vertical or Y direction of the input image will provide a reference for defining orientation angle 580. In one embodiment, a virtual axis may be taken in the direction from bottom to top of a graphical object, and orientation angle 580 is measured counterclockwise from that virtual axis.

Width 590 and height 595 fields may be extracted from the bounding box of a graphical image identified by identifier 515 and entered in the corresponding row of data stricture 500. Width 590 and height 595 may be taken from the length and breadth of text bounding contours. Such length and breadth calculation results are independent of orientation angle 580.

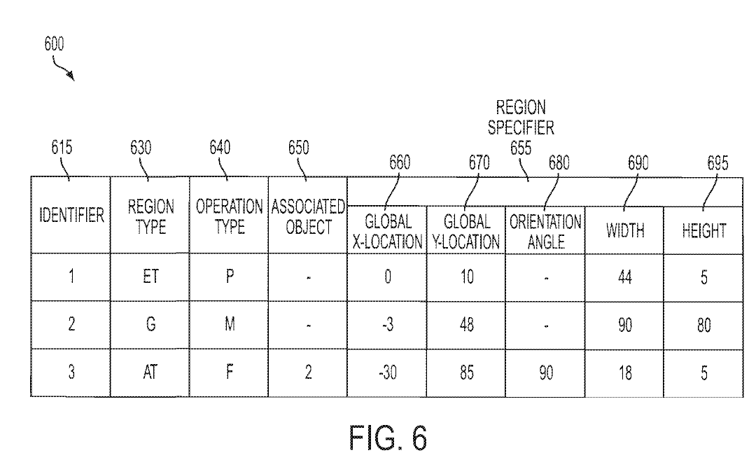

FIG. 6 shows an exemplary case applying data structure 500 to selected elements of FIG. 4. Specifically, the text APARTMENT DIAGRAM which lies within an instance of exterior text bounding contour 418, the line drawing of an apartment which is graphical image 410, and the text UTILITY which lies within an associated text bounding contour 412. These items are identified and assigned 1, 2, and 3, respectively, and these identifiers stored in identifier field 615. Each region may be designated type ET, G, and AT, respectively, and the region type designator recorded in region type field 630, respectively. The desired operation type for item 1 identified by identifier 615, or region type ET, may be P which indicates preserve this region. The desired operation type for item 2, of region type G, may be M which indicates mirror this region. The desired operation type for item 3, of region type AT, may be F which indicates flip this region. For item 3, the presence of the F operator may indicate that associated object field may be used to obtain the identifier for a graphical object to use to obtain a virtual axis. In this case, item 3 is associated with item 2 and that association is recorded on the item 3 row of associated object field 640.

Region specifier 655 may contain global X-coordinate 660 and global Y-coordinate 670 of the centroids of each item identified in identifier 615. Region specifier 655 may also contain an orientation angle 680 of associated text. In this exemplary case, the orientation angle 680 of the text UTILITY is 90 degrees measured counterclockwise from the virtual axis of item 2. The global X-coordinate 650, global Y-coordinate 670, width 690, and height 695 may be recorded in units for which the original image is contained in a box from (−50,0) to (50,100). For this example and in these units, the centroids the items are (0,10), (−3,48), and (−30, 85) respectively. In this exemplary case, the global positions of the centroids of items 1 and 2 in the output image are (0,10) and (−3, 48) respectively. The local position of item 3 relative to item 2 is (−30−(−3), 85−48)=(−27,37). The arithmetic inverse of the local X-coordinate is computed producing (27,37). The locally mirrored coordinate is added to the global coordinate for the mirrored centroid of item 2, producing a global coordinate (27,37)+(−3,48)=(24, 85). For this exemplary case and with reference to FIG. 4, the text UTILITY will appear in the upper right hand corner of the mirrored apartment diagram and the text APARTMENT DIAGRAM will appear undisturbed.

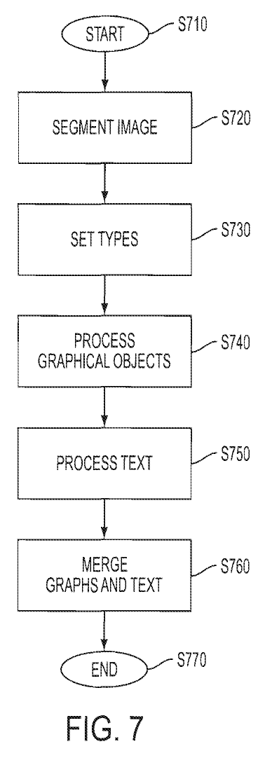

FIG. 7 shows a flowchart outlining an exemplary process of the selective text flipping and image mirroring system. The process begins in step S710 and proceeds to step S720 where regions containing graphical objects and text objects of an input image are identified. The segment image step S720 may use pixel connectedness metrics and contour following operations. Image object segregation may not require extracting or identifying text characters within a text region. Text, as used in this specification, can be a region which can be treated as a unit without need for optical character recognition to assign values from a finite, countable symbol set or alphabet. Once segmented, the process proceeds to step S730.

In step S730 the objects can by identified by type. Labels, such as graphical objects, external text objects, and associated objects can be used to identify the object type and to differentiate regions so subsequent image manipulation operations may be used selectively. As in the above examples, regions types for graphical objects, external text objects, associated objects and other objects may be distinct. Step S730 may also record the type of operations needed for each region identified. The operation may be a sequence of transformations. Elemental operation in each sequence need not be unique to a given operations, but may instead be used in other sequences. The order of operations in each sequence may be important since transformation operators need not be commutative. As an example, translation and rotation are not commutative since translating an object then rotating it generally produces a different result than rotating the object then translating the rotated object. The process can then proceed to step S740.

In step S740, graphical objects may be processed. For example, graphical objects can be processed so as to replace non-graphical objects with background, copy the processed graphical image to a graphical plane, and mirror image the graphical object. These operations may be commutative so they may be performed in any order. Mirror imaging may be performed with respect to each graphical object centroid or by using an offset mirror axis and translating by approximately twice the offset as described previously. The process then proceeds to step S750.

In step S750, text can be processed. For example, text regions may be segregated to one or more text planes, rotated as required, and either placed in corresponding positions for associated text, or preserved in their position and orientation for external text. The process of flipping text may be implemented by centering an associated text object, rotating by an angle determined by the orientation of the text from vertical, then translating the rotated text to a corresponding position. The operational sequence described for associated text preserves its readability and may be described as isomorphic. External text may be simply mapped as is to its output position with its orientation retained in a text plane. As described above, this operation is automorphic. The process then proceeds to step S760.

In step S760, graphics and text may be recombined to form a modified image in which the text is selectively flipped and graphical objects are mirrored. In one example, there may be two planes or a plane for graphics, a separate plane for associated text, and a separate plane for external text. There may be a separate plane for each object. In such case, all the planes can be reassembled to form the modified image.

The program flow may end in step S770. Program housekeeping functions may be performed in this step. Memory cleanup, plane content erasure, release of memory or allocation or de-allocation of resources may be performed. The results of program flow may be communicated to exterior hardware or interfaces.

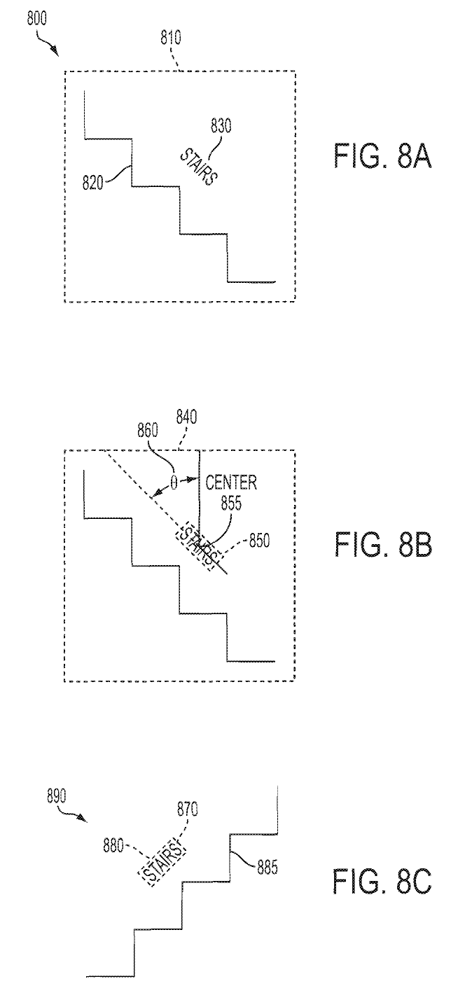

FIG. 8 shows a sequence of images 800 with an example of inclined text 830 and a graphical object 820 in an exemplary input image 810. FIG. 8 provides a specific example of flipping text and mirroring a graphical object. In FIG. 8, the stairs 820 are a line drawing and the inclined text 830 is not horizontally oriented. The sense of orientation angle 860 may be taken to be positive for any counterclockwise orientation from an axis parallel to the graphical object virtual axis. The inclined text 830 located in text bounding contours 850 is rotated counterclockwise about center 855 by an angle of approximately 180° minus twice orientation angle 860. Alternative definitions of the angular reference or sense of rotation may be applicable provided any alternative rotation definition is consistently used. Once the rotated text 870 is available, it may be placed in a rotated text bounding contour 880 at its corresponding position and merged with the mirrored stairs 885 to produce output image 890.

As shown in FIG. 2, processor device 130 is preferably implemented using an application specific integrated circuit (ASIC). However, processor device 130 can also be implemented using any other known or later developed integrated circuit, such as a digital signal processor, a hardwired electronic or logic circuit such as a discrete element circuit, a programmable logic device such as a PLD, PLA, FPGA or PAL, or the like. In general, any integrated circuit or logic device capable of implementing a Turing machine that is in turn capable of executing the flowchart shown in FIG. 7, can be used to implement processor device 130.

Thus, it should be understood that the block diagram shown in FIG. 2 can be implemented as portions of a suitably designed ASIC. Alternatively, the block diagrams shown in FIG. 2 can be implemented as physically distinct hardware circuits using a FPGA, a PLD, a PLA or a PAL, or using discrete logic elements or discrete circuit elements. The particular form of the block diagrams shown in FIG. 2 can be a matter of design choice and will be obvious and practicable to those skilled in the art.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method of manipulating an image comprising:
separating the image into a first object and a second object;
processing the first object so as to mirror the first object about an axis;
processing the second object so as to mirror a first position of the second object about the axis and arranging the second object at the mirrored position; and
combining the first object and the second object to form an output image.

2. The method of manipulating an image according to claim 1, wherein the first object includes a graphical image and the second object includes text.

3. The method of manipulating an image according to claim 1, wherein the step of processing the first object includes defining the axis as a vertical line passing through a centroid of the first object.

4. The method of manipulating an image according to claim 1, wherein the second object overlaps the first object.

5. The method of manipulating an image according to claim 1, further comprising:
displaying the output image on an image display; and
receiving user approval of the output image.

6. The method of manipulating an image according to claim 1 further comprising printing the output image.

7. The method of manipulating an image according to claim 1 image further comprising:
inputting the image by at least one of scanning the image and receiving the image in a digital form.

8. The method of manipulating an image according to claim 1, wherein separating the image into the first object and the second object further includes identifying regions by an object type, including at least one of a graphical object, associated text object, and an exterior text object.

9. The method of manipulating an image according to claim 8, wherein processing the first object so as to mirror the first object about the axis further includes:
defining the axis as a vertical line passing through a centroid of a graphical object; and
mirroring a graphical object by performing an arithmetic inverse on horizontal axis coordinates of each pixel of the graphical object relative to the axis.

10. The method of manipulating an image according to claim 1, wherein mirroring the first position of the second object about the axis includes performing an arithmetic inverse operation on the horizontal axis coordinate of the first position relative to the axis.

11. The method of manipulating an image according to claim 1, wherein combining the first object and the second object to form an output image includes rendering the first object before rendering the second object.

12. An apparatus that manipulates an image comprising:
a memory; and
a controller that is coupled to the memory that separates the image into a first object and a second object, processes the first object so as to mirror the first object about an axis, processes the second object so as to mirror a first position of the second object about the axis and arranges the second object at the mirrored position, and combines the first object and the second object to and stores an output image in the memory.

13. The apparatus that manipulates an image according to claim 12, wherein the first object includes a graphical image and the second object includes text.

14. The apparatus that manipulates an image according to claim 12, wherein when the controller processes the first object, the controller defines the axis as a vertical line passing through a centroid of the first object.

15. The apparatus that manipulates an image according to claim 12, wherein the second object overlaps the first object.

16. The apparatus that manipulates an image according to claim 12, further comprising:
an image display that is coupled to the controller that displays the output image; and
a user interface that is coupled to the controller that receives a user approval of the output image.

17. The apparatus that manipulates an image according to claim 12 further comprising a printing device that is coupled to the controller that prints the output image.

18. The apparatus that manipulates an image according to claim 12 further comprising:
an input device that inputs the image by at least one of scanning the image and receiving the image in a digital form.

19. The apparatus that manipulates an image according to claim 12, wherein when the controller separates the image into the first object and the second object, the controller identifies regions by an object type, including at least one of a graphical object, associated text object, and an exterior text object.

20. The apparatus that manipulates an image according to claim 19, wherein when the controller processes the first object so as to mirror the first object about the axis, the controller:
defines the axis as a vertical line passing through a centroid of a graphical object; and
mirrors a graphical object by performing an arithmetic inverse on horizontal axis coordinates of each pixel of the graphical object relative to the axis.

21. The apparatus that manipulates an image according to claim 12, wherein when the controller mirrors the first position of the second object about the axis, the controller performs an arithmetic inverse operation on the horizontal axis coordinate of the first position relative to the axis.

22. The apparatus that manipulates an image according to claim 12, wherein when the controller combines the first object and the second object to form an output image, the controller renders the first object before rendering the second object.

23. A multifunction device that manipulates an image comprising:
an input device that receives the image;
an output device that prints an output image; and
a controller that is coupled to the input device and output device, the controller receives the image, separates the image into a first object and a second object, processes the first object so as to mirror the first object about an axis, processes the second object so as to mirror a first position of the second object about the axis and arranges the second object at the mirrored position, combines the first object and the second object to form the output image, and transmits the output image to the output device to be printed.
